(19) United States
(12) Patent Application Publication
(10) Pub. No.: US 2018/0235143 A1
(43) Pub. Date: Aug. 23, 2018

(54) DISTRIBUTOR WITH AT LEAST TWO DISTRIBUTOR DISKS WITH VARIABLE SPEED

(71) Applicant: RAUCH LANDMASCHINENFABRIK GMBH, Sinzheim (DE)

(72) Inventors: Thomas ZEITVOGEL, Rheinmünster (DE); Volker STÖCKLIN, Ringsheim (DE)

(21) Appl. No.: 15/758,538

(22) PCT Filed: Sep. 16, 2016
(86) PCT No.: PCT/EP2016/001562

§ 371 Date: Mar. 8, 2018

(30) Foreign Application Priority Data
Sep. 18, 2015 (DE) 10 2015 011 949.4

(51) Int. Cl. A01C 17/00; A01C 19/04; A01C 15/16; F16H 3/00; F16D 25/10

(52) U.S. Cl. CPC A01C 17/005; A01C 17/008; F16D 25/10; A01C 15/16; F16H 3/006; A01C 19/045

(57) ABSTRACT

A distributor includes two distributor disks, which are driven rotatably by a drive train, to be attached to a power take-off shaft of a traction unit or of a tractor. The drive train includes a central input shaft driving a cross shaft to drive distributor disks via a central gear. The distributor disks can be rotated at different speeds with a reducing gear with variable output speed, arranged downstream of the central gear. The reducing gear is configured as a mechanical coaxial transmission with an input shaft connected to the cross shaft and an output shaft arranged coaxially to the cross shaft. A speed reduction ratio is changed by an adjusting element between a normal position, with an input speed of the input shaft corresponding to the output speed of the output shaft, and a speed reduction position with the input speed not equal to the output speed.

### CROSS REFERENCE TO RELATED APPLICATIONS

This application is a United States National Phase Application of International Application PCT/EP2016/001562, filed Sep. 16, 2016, and claims the benefit of priority under 35 U.S.C. § 119 of German Application 10 2015 011 949.4, filed Sep. 18, 2015, the entire contents of which are incorporated herein by reference.

### FIELD OF THE INVENTION

The present invention pertains to a distributor with at least two distributor disks, which are driven rotatably by a drive train that can be connected to a power take-off shaft of a traction unit or a tractor, wherein the drive train comprises a central input shaft, which drives a cross shaft used to drive a respective distributor disk via a central gear, wherein at least one of the distributor disks can be rotated by means of a reducing gear arranged downstream of the central gear with variable output speed at a speed different from that of the other distributor disks, wherein the reducing gear has an adjusting element for changing its output speed.

### BACKGROUND OF THE INVENTION

Distributors of this type are widely used especially in the form of so-called centrifugal or twin disk fertilizer spreaders in agriculture to distribute granular fertilizers. Other fields of use are in snow and ice control and in road construction for distributing crushed gravel, de-icing salt or other abrasives ranging from the powdered to the granular form. While a drive of their own, for example, a hydraulic or electric drive, may be associated, in principle, with the distributor disks, they are also often attached to a respective carrier shaft of a drive train, which is unpowered itself in terms of a simple and cost-effective configuration, in which case the drive train can be connected to the power take-off shaft of a traction unit or a tractor via a central input shaft, which is located at its end facing away from the carrier shafts of the distributor disks, in order to set the distributor disks into rotation, usually in the opposite direction. The drive train comprises for this purpose, as a rule, a central gear, e.g., an angular or miter gear, which is provided with conical gear wheels and via which the central input shaft is in rotary connection with the cross shaft. The cross shaft is, in turn, in rotary connection with a respective carrier shaft of a respective distributor disk.

Such mechanical drives of the distributor disks through the power take-off shaft of the traction unit or tractor have proved successful in practice for decades and are characterized by lower production costs as well as by very great robustness without appreciable maintenance effort compared to hydraulic or electric drives, which have a more complicated configuration but are, however, more comfortable. The drawback of such distributors, which are unpowered themselves and are driven simply mechanically by means of the power take-off shaft, is, however, mainly the lack of adaptability or the insufficient adaptability to different operating conditions, for example, the coverage of greater working widths, the lack of the possibility of adjusting to different, smaller working widths as well as the insufficient adaptation to different types of de-icing salts and types of distribution, such as normal spreading, border spreading or spreading along edges or also for switching to partial widths, such as the spreading of field wedges and the like. Such an adaptation is only possible by means of replaceable distributor disks, replaceable throwing blades or throwing blades of variable length and/or position or even by tilting the entire spreading unit. However, said measures represent a great work effort for the operator and require, moreover, corresponding care. The requirement to guarantee a uniform spreading density with each adjustment is always in the foreground.

Uniform spreading density is achieved with normal spreaders in agriculture by overlapping the spreading patterns while moving over adjacent driving lanes. Spreading patterns with flat flanks, which are given especially in case of the currently desired great working widths, are especially suitable for achieving a uniform spreading density due to overlapping. However, they lead, especially at the border of the field, where material is spread on one side only and there is consequently no overlap, to underspreading if material is spread to the border of the field only, or to spreading beyond the field border and hence to corresponding losses of fertilizer. Overspreading must definitely be avoided in many cases if, for example, the crops or plants on the adjacent field do not need fertilization or need a different fertilizer or else if there is a body of water or a road along the border.

To guarantee uniform spreading density during spreading along edges and to avoid overspreading beyond the border, a spreading pattern with a steep flank must be ensured on the side of twin disk spreader facing the edge, while the usual flat spreading pattern must be maintained towards the middle of the field. To solve this problem of spreading along edges, either special edge spreading disks must be mounted or else the throwing blades must be removed or adjusted on the distributor disk facing the edge. It is even necessary in case of a plurality of working width ranges to have a plurality of edge spreading disks available, or the throwing blades must be set differently. In addition, the feed point may be changed, as this is known, for example, from EP 0 410 312 A1. All these solutions have the drawback that an interruption in the spreading operation is necessary and the farmer must leave the tractor to carry out the corresponding adjustments. In many cases, this adjustment is not carried out because of the time and work effort needed, with the result that not enough material will be spread on the strip at the edge or material will be spread beyond the edge.

Numerous attempts have therefore been made to make possible the adjustment for the spreading along edges by remote control from the traction unit or from the tractor. This is effected, for example, by changing the feed point on one side only and/or by tilting the spreading unit at the three-point hitch of the tractor. These methods are, however, extremely inaccurate and especially not variable enough.

Moreover, it is known, in particular, that speed-controllable gears may be provided in the drive train of the distributor disks, so that the latter can be driven at different speeds. It shall be possible in this manner not only to vary the working width, but also to change the spreading width on one side, e.g., for spreading along edges. Prior-art variable-speed gears for this purpose are, however, very complicated and expensive and their production cost is therefore practically the same as that of single hydraulic drives (EP 0 330 839 A1), by means of which the task of spreading along edges can be solved in a comfortable manner, but which are too expensive for many farms, and whose function is, as a rule, also rather unreliable.

DE 36 17 302 A1 shows a distributor configured in the manner of a centrifugal spreader with a plurality of distributor disks, for each of which a separate gear of its own, whose speed is variable, is provided. The document shows for this embodiments with a total of four distributor disks, two of which are each arranged on both sides of the input shaft. The outer distributor disks can be driven and set into rotation by the shafts of the inner centrifugal disks via a gear of their own, such as a V-belt drive, so that they may have a different speed compared with these. This is likewise complicated and costly, especially since the gears are provided in pairs.

Another gear, which is intended for farm equipment, especially fertilizer spreaders, and which is arranged between the cross shaft provided for driving the distributor disks and the central input shaft and thus it replaces the otherwise common bevel or miter gear, is known from EP 1 782 670 A1. To set the distributor disks into rotation at the same speed or at different speeds, the gear is configured as a so-called power shift gear, in which the drive torque acts continuously on the driven shaft during a speed change during shifting between different gear ratios. The central input shaft is in rotary connection for this purpose via different gears with a transmission shaft arranged parallel to the—right and left—cross shafts, which can be caused to mesh, as desired, by means of three spur gears mounted thereon, with one of three spur gears, which are mounted on a selector shaft, which is mounted coaxially with the two cross shafts and between these. To drive the cross shafts at the same speed or at different speeds, one of the spur gears of the transmission shaft is caused to mesh with one of the spur gears of the selector shaft, while different gear ratios are obtained depending on the combination of the gears. To prevent overload, plate packs, which are in connection with one another in a non-positive manner, may, moreover, be provided between the selector shaft and the two cross shafts. Aside from the fact that the design of the prior-art gear is very complicated and therefore expensive, a continuous speed change of at least one of the two distributor disks is not possible, and the gear requires a very large space for its installation, which is available in distributors of this class only with limitations.

DE 199 29 356 C2 describes a distributor of this class in the form of a twin disk spreader, in which one of the two distributor disks can be rotated by means of a reducing gear with variable output speed arranged downstream of the central gear, i.e., on the side thereof facing away from the central input shaft, at a speed different from that of the other of the two distributor disks. However, the solutions proposed in this document have not yet reached the production stage because of technical problems. Thus, on the one hand, especially the hydraulic transmissions provided with hydraulic motors have proved to be unreliable in terms of function and require maintenance. On the other hand, the mechanical transmissions have also proved not to be sufficiently suitable for practical applications, because the belt drives used for this purpose are susceptible to wear and do, moreover, require space for their installation, which requires conversion of the entire drive train of the distributor disks. If the bevel or miter gear connecting the carrier shaft of the distributor disk to the cross shaft is formed by a friction gear, in which the friction gears that are in contact with one another can be displaced in relation to one another into different radial positions by means of actuators, the speed change brought about hereby is found to be relatively small, and the wear, which leads to the need for maintenance, also proved to be relatively great.

### SUMMARY OF THE INVENTION

Based on this, a basic object of the present invention is to perfect a distributor of the type described in the introduction in a simple and cost-effective manner such that the distributor disks can be driven at variable speeds in a robust, durable and reliable manner by remote control, so that, in particular, spreading along edges and border spreading as well as preferably also spreading in wedges is possible, and, in particular, a continuous change in the speed of at least one of the distributor disks should be guaranteed.

This object is accomplished according to the present invention in a distributor of this type such that the reducing gear is configured as a mechanical coaxial transmission, whose input shaft is connected to the cross shaft and whose driven shaft is arranged coaxially to the cross shaft, wherein the speed reduction ratio can be changed by means of the adjusting element between a normal position, in which the input speed of the input shaft essentially corresponds to the output speed of the driven shaft, and at least one speed reduction position, in which the input speed of the input shaft is not equal to the output speed of the driven shaft.

Based on the purely mechanical load transmission of the torque of the input shaft of the coaxial transmission, which input shaft is connected to the cross shaft in a non-rotatable manner, to the driven shaft thereof, the embodiment according to the present invention offers great robustness and functional reliability with only an extremely low maintenance effort. Based on the coaxial arrangement of the input shaft of the coaxial transmission with the driven shaft, only a very small space is, moreover, needed for installation, so that the coaxial transmission according to the present invention can be installed in the usual frame construction of distributors of this class without problems, without having to change the configuration of the entire drive train of the distributor disks.

If the mechanical coaxial transmission is in its normal position, in which the input speed of the cross shaft or of the input shaft of the coaxial transmission, which input shaft is connected hereby non-rotatably, essentially corresponds to the output speed of the driven shaft, both distributor disks are driven at about the same speed, so that the spreading width of the two disks is equal and the desired working width is achieved for the normal spreading. The distributor may, of course, further be set according to one or more of the above-described, conventional methods to different working widths, so that all the parameters necessary for the normal spreading operation can be varied in connection with a quantity of material to be spread, which can usually be set by means of suitable dispensing elements, which feed the material to be spread to the distributor disks in a presettable and/or controllable mass flow. By shifting the coaxial transmission from such a normal position into at least one speed reduction position or preferably into more speed reduction positions, the output speed of the coaxial transmission is changed, especially in the direction of an output speed that is lower than the input speed, so that the respective distributor disk that is in rotary connection with the driven shaft can be set into rotation at a correspondingly different, especially lower speed. As a consequence, it is possible to carry out, for example, spreading along edges or border spreading because it is possible, due to the reduced speed, not only to reduce the spreading width of the distributor disk located on this side, but also to displace at the same time the spreading fans thereof toward the edge and to obtain a spreading pattern with steeper flanks thereby. The latter can be achieved by means of a device known as such from the state of the art for adjusting the feed point of the material to be spread to the distributor disk(s), be it radially and/or especially in the circumferential direction of the distributor disk (cf., for example, DE 10 2005 030 781 A1 or DE 10 2007 053 550 A1).

It should be noted here that it is sufficient for many applications if the speed of only one of the distributor disks can be varied by means of the coaxial transmission according to the present invention, while the speed of the other distributor disk(s) is preset by the speed of the power take-off shaft of the tractor or of the traction unit (for spreading along edges or for border spreading, the spreader should then move, for example, in the direction in which the variable-speed distributor disk faces the border of the field). However, it is, of course, also possible, instead, for both distributor disks—or for all distributor disks in case of a centrifugal spreader with more than two distributor disks—to have variable speed by means of a respective coaxial transmission if, for example, spreading in wedges of fields tapering to a tip or a partial spreading mode is desired in any direction of travel of the distributor.

The adjustment of the desired output speed or the desired speed of the respective distributor disk can be carried out without problems by means of the adjusting element used to change the speed reduction ratio of the coaxial transmission according to the present invention from the tractor or from the traction unit via a manual, electrical or hydraulic adjusting means, as it will be explained in more detail below in the form of a preferably provided adjusting cylinder, and, if desired, the particular speed reduction ratio can also be visualized in the driver's cab, so that the operator does not have to leave the driver's cab and, in particular, does not have to make a retooling during the spreading operation.

In an advantageous embodiment, it is possible based on the compact and space-saving mode of construction of the mechanical coaxial transmission that the coaxial transmission is arranged in a housing accommodating the cross shaft or is integrated in such a housing, and the adjusting element passes, in particular, essentially radially through the housing. The coaxial transmission is consequently protected from external effects, especially dirt, and the risk of corrosion is minimized. The adjustment of the coaxial transmission between its normal position and one or more seed reduction positions then takes place from the outside of the housing by means of the adjusting element passing through same. The term “integrated in the housing accommodating the cross shaft” otherwise addresses especially a preferred embodiment, in which the gearbox of the coaxial transmission itself forms a part of the cross shaft.

As was already suggested, the coaxial transmission may preferably have a plurality of speed reduction positions with different output speeds, and essentially continuous adjustment between the plurality of speed reduction positions may, in particular, be possible by means of the adjusting element in order to adjust the desired output speed or the speed of the distributor disk connected to the output shaft, e.g., via a conventional mechanical bevel gear or miter gear, to practically any desired value.

If the coaxial transmission has a plurality of speed reduction positions with different output speeds, provisions may advantageously be made for arranging a speed sensor

on the output side of the coaxial transmission, especially at the output shaft thereof (or, e.g., also on a shaft connected to this non-rotatably, including the carrier shaft carrying the respective distributor disk), and possibly

on the input side of the reducing gear, especially on the input shaft thereof (or, e.g., also on the cross shaft connected non-rotatably to the input shaft or on the central input shaft of the drive train),

wherein the speed sensor or the speed sensors is/are in connection especially with a control and/or regulating unit, by means of which the output speed can be controlled and/or regulated according to a set point. While the output-side speed sensor may be used basically only to visualize the actual speed of the distributor disk in the driver's cab, so that it is displayed to the operator whether the coaxial transmission is in the normal position or in a certain speed reduction position, whereupon he can change the desired position by actuating the adjusting element, the speed sensor or speed sensors may be in functional connection with a control and/or regulating unit, which may also be used to control or regulate other parameters of the spreading, such as the desired quantity to be spread by means of the dispensing elements, the desired feed point by means of the device for adjusting the feed point of the material to be spread onto the distributor disks, etc., so that the desired output speed, which can be entered into an input device of the control and/or regulating unit, can be controlled and/or regulated according to a desired set point.

While the coaxial transmission according to the present invention may have, in principle, any desired mode of construction of prior-art reducing gears, in which a purely mechanical torque transmission of its input shaft to its output shaft is ensured while a speed change is guaranteed on the output side by means of an adjusting element (a mechanical adjusting gear equipped with roller bodies, e.g., in the manner of a so-called NuVinci transmission, which is capable of reproducing the kinematics of a planet gear and makes especially a continuous change of speed possible, shall only be mentioned as an example in this connection), a coaxial transmission configured especially as a friction clutch transmission proved to be especially advantageous based on its great robustness in conjunction with its very compact mode of construction.

Provisions may be made in an advantageous embodiment in such a friction clutch transmission for the aforementioned reasons as well as in view to a reliable torque transmission for both the input shaft of the friction clutch transmission and its output shaft to have a plate each, especially a plurality of plates, which advantageously extend in a plane advantageously arranged approximately at right angles to the axis of rotation of the input shaft and of the output shaft, i.e., in a radial plane or in a plane or planes that is a radial plane or are radial planes in this respect can be brought into contact with one another in a non-positive or frictionally engaged manner. In case of a plurality of plates, these may be configured especially in the form of plate packs, in which case the plates of the plate pack of the input shaft and the plates of the plate pack of the output shaft are arranged alternatingly in the axial direction, so that the plates of one plate pack of the input shaft mesh between the plates of the other plate pack of the output shaft and vice versa.

To make it possible to vary the output speed, especially continuously, in relation to the input speed, the plates of the input shaft and of the output shaft may preferably be stressed, especially by means of a pressing ring displaceable in the axial direction, with variable pressure in order to change the slip occurring during the operation between the at least one plate of the input shaft and the at least one plate of the output shaft and consequently the output speed. Consequently, if the plates are stressed against one another with maximum pressure or the “compression” of the plates or of the plate packs is at its maximum, the slip between the plates of the input shaft and those of the output shaft has its minimum and is especially equal to zero, so that the speed of the output shaft corresponds to that of the input shaft. If, by contrast, the plates are stressed against one another with minimum pressure or no pressure and the “compression” of the plates or plate packs has its minimum, the slip between the plates of the input shaft and those of the output shaft has its maximum, and the contact between the plates may even be eliminated altogether, so that the speed of the output shaft is lower than that of the input shaft, and may possibly drop to zero. It should, however, be noted in this connection that the plates themselves are preferably manufactured from essentially rigid materials, such as metal (alloy) or metal (alloys) and thus they do not practically undergo any change in volume during the operation at variable pressures against one another.

The adjusting element of the friction clutch transmission, which is used to change the speed reduction ratio of the output shaft in relation to the input shaft, may preferably comprise an actuator-type adjusting element, which has especially a hydraulic, pneumatic or hydropneumatic piston-and-cylinder unit. Consequently, the piston of the piston-and-cylinder unit of the actuator-type adjusting element, which piston is displaceable in relation to the cylinder, is used to vary the speed of the output shaft of the friction clutch transmission in relation to the input shaft thereof, wherein a respective relative position of the piston in relation to the cylinder is representative of a certain speed reduction ratio.

Provisions are advantageously made in this connection in an embodiment having a simple design and reliable function for the cylinder of the piston-and-cylinder unit of the actuator-type adjusting element to be in connection with an annular space, which is arranged in a housing of the friction clutch transmission and which adjoins in the axial direction—be it directly or indirectly via an additional pressing element, which is axially displaceable together with the pressing ring—the axially displaceable pressing ring and is used for the axial displacement of same as a function of the (fluid) pressure prevailing in the annular space. The plates of the input shaft and of the output shaft can be stressed (as well as released) against one another in this manner by the pressing ring being axially displaced in the direction of the plates by means of the fluid pressure generated in the annular space by the piston-and-cylinder unit, and the plates are consequently stressed against one another axially in the direction of the plates while the slip decreases or is even completely eliminated (the output speed increases), or the pressing ring is displaced axially away from the plates by means of the—different—fluid pressure generated in the annular space by the piston-and-cylinder unit, so that the plates are consequently released while the slip increases (the output speed decreases).

Provisions may be made in another advantageous embodiment for the plates of the input shaft and of the output shaft

to be prestressed towards one another mechanically, especially by means of spring force, in order to bring them into contact with one another; or

to be prestressed away from one another mechanically, especially by means of spring force, in order to bring them out of contact with one another,

wherein the plates of the input shaft and of the output shaft

can be stressed away from one another by means of the adjusting element against the mechanical prestress in order to increase the slip; or

can be prestressed towards one another by means of the adjusting element against the mechanical prestress in order to reduce the slip.

The mechanical prestress on the plates towards one another or away from one another may be effected especially by means of springs, for example, coil springs, which act on the pressing ring in the axial direction, wherein a plurality of, e.g., three or more springs arranged distributed over the circumference may advantageously be provided around the entire circumference of the input shaft and the output shaft for the purpose of a uniform mechanical prestress on the plates and on the pressing ring. If the actuator-type adjusting element comprises in this case a hydraulic, pneumatic or hydropneumatic piston-and-cylinder unit of the aforementioned type, provisions may consequently be made, depending on the arrangement of the annular space in relation to the pressing ring, for

the plates prestressed mechanically towards one another to be released by increasing the fluid pressure applied by means of the piston-and-cylinder unit (the pressure increases in the annular space, so that the pressing ring is displaced axially away from the plates; the slip between the plates consequently increases, so that the output speed decreases); or

the plates prestressed mechanically away from one another to be stressed by increasing the fluid pressure applied by means of the piston-and-cylinder unit (the pressure increases the annular space, so that the pressing ring is displaced axially towards the plates; the slip between the plates consequently decreases, so that the output speed increases).

As was already suggested, especially a slip-free contact can be generated between the input shaft of the friction clutch transmission and the output shaft thereof, so that the input speed corresponds to the output speed. The normal spreading takes place in this manner with equal speeds of the distributor disks, which accounts for the overwhelming majority of the spreading operations, when there is a slip-free connection, i.e., a connection not subject to any losses of friction, between the input shaft of the coaxial transmission configured as a friction clutch transmission and the output shaft thereof. Further, such a slip-free connection during the normal operation does not require any control or regulation of the output speed in relation to the input speed.

As was mentioned above, the desired output speed or the desired speed of the respective distributor disk should preferably be able to be adjusted from a distance, such as from the driver's cab of a tractor or by means of a portable operating module, etc. While any desired manual, electrical or hydraulic adjusting units are considered, in principle, for this purpose, which are suitable for actuating the adjusting element of the coaxial transmission, provisions may be made for this in an advantageous embodiment for the actuator-type adjusting element

to comprise an especially hydraulic, electrical or electromagnetic adjusting cylinder or a piezo motor, which is in mechanical connection with the piston of the hydraulic, pneumatic or hydropneumatic piston-and-cylinder unit, in order to actuate the piston thereof and thus to change the fluid pressure brought about hereby; or

to comprise a controllable and/or regulatable pump, which is in fluidic connection with the cylinder of the hydraulic, pneumatic or hydropneumatic piston-and-cylinder unit, in order to actuate the piston thereof and thus to change the fluid pressure brought about thereby.

In the first case, the adjusting cylinder may be, for example, a hydraulic adjusting cylinder, which is fed, e.g., by the hydraulic system of the traction unit or of the tractor and comprises a preferably regulatable pressure control valve, or it may be especially an electrical or electromagnetic adjusting cylinder, which is supplied with power, for example, by the onboard electrical power supply system of the traction unit or of the tractor. Further, piezoelectric, preferably linear drives of the piston-and-cylinder unit are conceivable. The controllable and/or regulatable pump may likewise be supplied with power by the onboard electrical power supply system of a traction unit or of a tractor; this also applies to any possible pressure sensors.

According to an advantageous variant of the coaxial transmission of the distributor according to the present invention, which is configured as a friction clutch transmission, provisions may be made for the friction clutch transmission to have, furthermore, a pump, especially in the form of a vane-type rotary pump or centrifugal pump, whose delivery-side port is in connection with a fluid duct, which opens at the plates of the input shaft and of the output shaft, which can be brought into contact with one another in a non-positive manner. The plates of the input shaft and of the output shaft, which can be stressed towards one another under variable pressure, can be lubricated in this manner not only by means of suitable lubricants, such as oil and the like, in order to minimize a possible wear especially in a speed reduction position, in which position a certain slip occurs between the plates, but cooling of the plates is especially also ensured in the speed reduction position(s) in order to dissipate the power loss generated in the form of heat in case of a slip as a consequence of friction. The lubricant can thus flow through the plates and the plates can be “rinsed” with the lubricant by means of the pump especially permanently, i.e., also when the friction clutch transmission is in its slip-free normal position.

The pump used to lubricate and/or cool the plates may advantageously be configured as an unpowered pump, wherein a pump wheel of the pump is connected especially non-rotatably to the input shaft, while the pump housing may be connected non-rotatably to a gearbox or optionally also to a housing surrounding the cross shaft of the drive train of the distributor disks. A drive of its own thus becomes unnecessary for the pump, because the drive takes place exclusively via the drive train of the distributor disks—or, more precisely, via the input shaft—which (drive drain or input shaft) is set into rotation by means of the power take-off shaft of the traction unit or of the tractor.

An embodiment of such a pump that is advantageous in terms of design, for example, in the form of a coaxial vane-type rotary pump, can be characterized in that the pump can be attached to an end face of the friction clutch transmission, especially to the input-side end face thereof The pump housing may be attached, snapped, screwed or otherwise attached now to the end face of a gearbox such that the pump wheel meshes with a profiling of the input shaft of the friction clutch transmission, which profiling is provided for this purpose, in a non-rotating manner.

Further features and advantages of the present invention appear from the following description of an exemplary embodiment with reference to the drawings. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a highly schematic lateral view of the terminal section of a drive train of a distributor configured in the form of a twin disk fertilizer spreader including distributor disks thereof when viewed from the rear;

FIG. 2 is a schematic detail view of an embodiment of the reducing gear with variable output speed of the right distributor disk in FIG. 1, which is configured as a mechanical coaxial transmission in the form of a friction clutch transmission and has an actuator-type adjusting element with a hydraulic piston-and-cylinder unit;

FIG. 3 is a schematic sectional view of the friction clutch transmission according to FIG. 2 along the section plane III-III, wherein the friction clutch transmission is in a position of maximum slip, in which an output speed is (markedly) lower than an input speed;

FIG. 4 is a sectional view of the friction clutch transmission, which view corresponds to FIG. 3, wherein the friction clutch transmission is in a position of minimum slip, in which its output speed corresponds to the input speed;

FIG. 5 is a schematic sectional view of the friction clutch transmission according to FIGS. 2 through 4 along the section line IV-IV in FIG. 2;

FIG. 6 is a schematic sectional view of the friction clutch transmission according to FIGS. 2 through 5 along the section plane V-V of FIG. 2;

FIG. 7 is a schematic sectional view of the friction clutch transmission according to FIGS. 2 through 6 along a section plane rotated by 90° about the central axis relative to the section plane III-III of FIG. 2 and in a position corresponding to FIG. 3; and

FIG. 8 is a simplified circuit diagram view of an adjusting element of the friction clutch transmission, which adjusting element is modified compared to the embodiment according to FIGS. 2 through 7.

### DESCRIPTION OF THE PREFERRED EMBODIMENTS

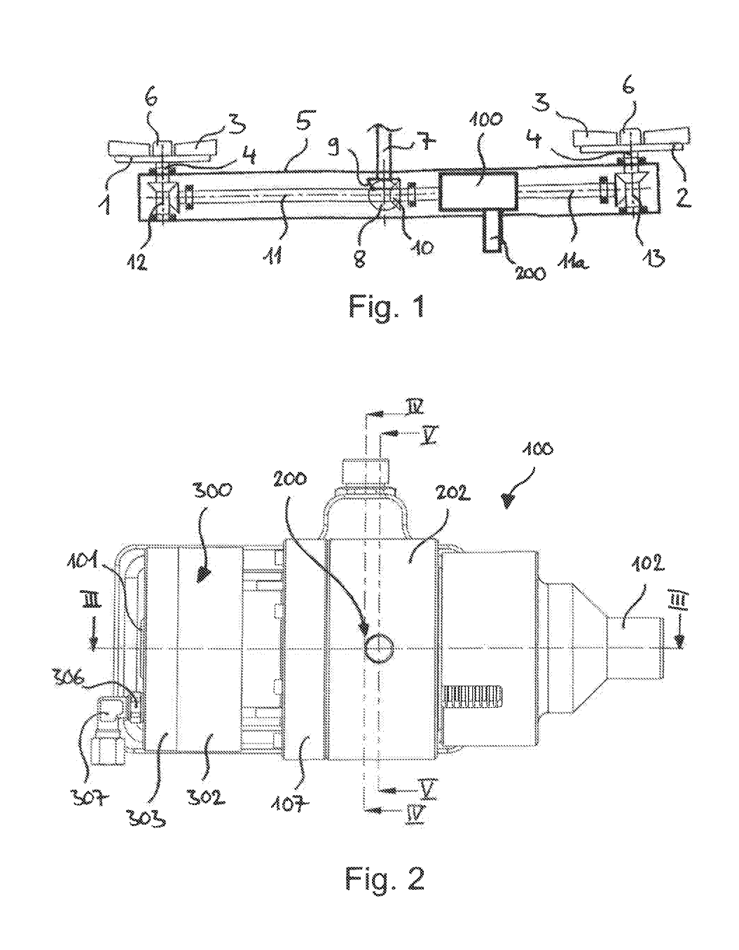

Referring to the drawings, the terminal or output-side section of the drive train of the distributor disks 1, 2 of a distributor in the form of a twin disk fertilizer spreader, which is not shown in more detail, which section is shown in FIG. 1, has the two distributor disks 1, 2, which are arranged in laterally spaced locations from one another and which are equipped each with throwing blades 3. The distributor disks 1, 2 are driven with opposite directions of rotation, and they rotate in this case opposite the direction of travel from the inside to the outside. Each distributor disk 1, 2 is seated non-rotatably and especially replaceably on an approximately vertical carrier shaft 4, which is mounted in a housing 5. A hub 6 arranged at the free end of each carrier shaft 4 is provided for fastening the throwing disks 4.

The distributor disks 1, 2 are located under a respective outlet (not shown) of a dispensing element, likewise not shown, which is, in turn, arranged under a discharge opening of a material container (likewise not shown in the drawing), which is carried together with the housing 5 by a frame. The latter has a usual coupling device (not shown), by means of which it can be received, in turn, by the three-point hitch of a tractor. The material being stored in the material container is fed via the outlets of the controllable and/or regulatable dispensing elements to the distributor disks 1, 2 in settable quantities. An agitator (likewise not shown), which has one agitating element or a plurality of agitating elements arranged above each discharge opening of the material container, runs in the material container.

The distributor disks 1, 2 are usually driven by the power take-off shaft, not shown, of the tractor, which power take-off shaft is connected to the drive train of the distributor disks 1, 2 of the distributor. The drive train comprises for this, for example, a universal-joint shaft (not shown), which is provided with a suitable coupling device at its free end and which is joined by a central input shaft 7 with a non-rotatable connection. The central input shaft 7 opens at its end facing away from the universal-joint shaft into a central gear 8 mounted in the housing 5 in the form of a bevel or miter gear, one (conical) gear 9 of which is seated on the input shaft 7 and another (conical) gear 10 of which is seated on a cross shaft 11, which is mounted in the housing 5. A bevel or miter gear 12, via which the carrier shaft 4 of the left distributor disk 1 shown in FIG. 1, which carrier shaft is likewise mounted in the housing 5, is driven, is arranged at the end of the cross shaft 11, which end is the left-hand end in FIG. 1.

The carrier shaft 4 of the distributor disk 2, which is the right-hand distributor disk in FIG. 1, is likewise mounted in the housing 5 and is in rotary connection via another bevel or miter gear 13, which corresponds, e.g., to the bevel or miter gear 12, with a shaft section 11a, which is likewise mounted in the housing 5, and which is likewise arranged coaxially to the cross shaft 11. The output speed of the power take-off shaft of tractors is usually in the range of about 540 rpm in practice. The central gear 8 and/or the bevel or miter gear 12, which is the left-hand bevel or miter gear in FIG. 1, then ensure, for example, a transmission in the direction of a speed that is higher, e.g., up to 2:1 higher.

While the distributor disk 1, which is the left-hand distributor disk in FIG. 1, is consequently always driven via the gear 8 and the bevel or miter gear 12 at the same transmission ratio in relation to the input shaft 7, the speed of the distributor disk 2, which is the right-hand distributor disk in FIG. 1, can be changed in a variable manner, and it can be rotated in this case between a speed that corresponds to the distributor disk that is the left-hand distributor disk in FIG. 1 and a speed that can be reduced compared to that in a variable manner, in order to ensure, for example, spreading along edges or border spreading or also spreading in wedges. A reducing gear 100 with variable output speed, which is arranged downstream of the central gear 8— or, more precisely, between the section of the cross shaft 11 located downstream of the central gear 8 and the shaft section 11a, which extends coaxially hereto and which opens into the bevel or miter gear 13 of the distributor disk 2, which is the right-hand distributor disk in FIG. 2, is provided for this purpose in the housing 5, in which the cross shaft 11 is mounted and which receives, further, both the central gear 8 and the two bevel or miter gears 12, 13. As will be explained below in detail with reference to FIGS. 2 through 7, the reducing gear 100 is a coaxial transmission with simply mechanical torque transmission, whose output speed can be varied by means of an actuator-type adjusting element 200, 400 practically continuously between a normal position, in which the input speed of the cross shaft 11 corresponds to the output speed of the shaft section 11a, and a more or less random speed reduction position, in which the input speed of the cross shaft 11 is not equal to—here: greater—than the output speed of the shaft section 11a. The reducing gear 100 configured as a mechanical coaxial transmission is accommodated in the housing 5 protected from dirt and moisture or may also be integrated in same.

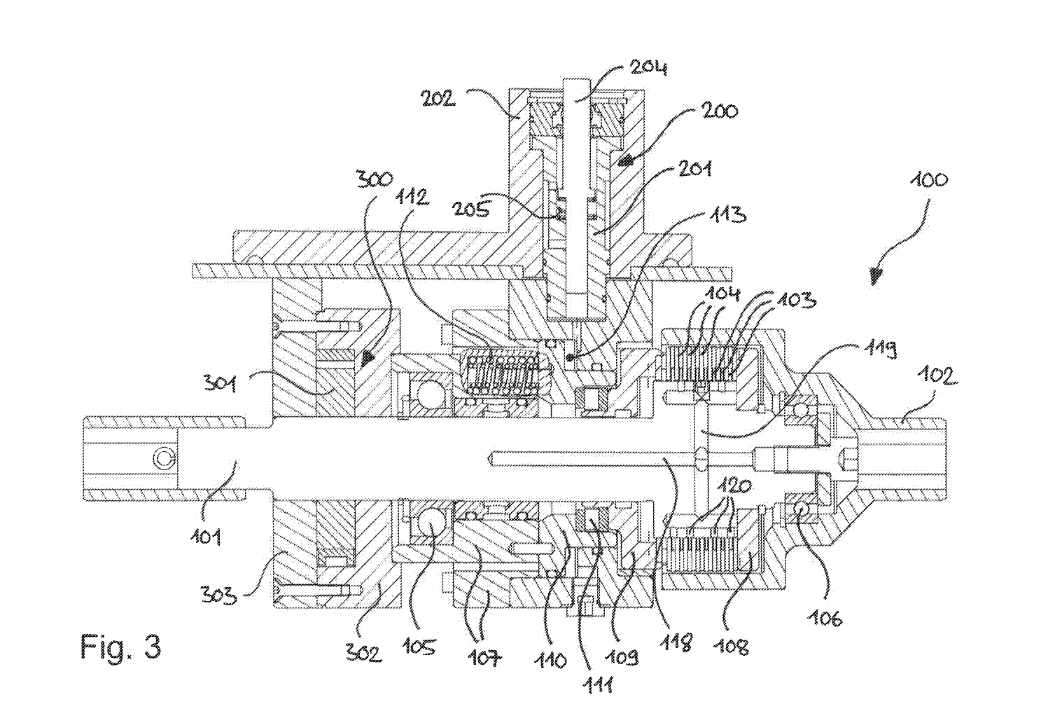

As can be seen especially in FIGS. 3, 4 and 7, which are longitudinal sections through the reducing gear 100 shown as a whole in FIG. 2 along two section planes arranged at an angle of 90°, the reducing gear 100 configured as a mechanical coaxial transmission comprises an input shaft 101, which is connected to the end of the cross shaft 11, which end is the right-hand end in FIG. 1 and faces away from the central gear 8, and a driven shaft 102, which is arranged coaxially hereto and which is connected to the end of the shaft section 11a, which end is the left-hand end in FIG. 1 and faces away from the right-hand bevel or miter gear 13. Speed sensors, not shown in the drawings, may be provided at the driven shaft 102 (or also at the shaft section 11a or at the carrier shaft 4 of the distributor disk 1, which is the right-hand distributor disk in FIG. 1), as well as preferably also at the input shaft 101 (or also at the cross shaft 11 or at the carrier shaft 4 of the distributor disk 2, which is the left-hand distributor disk in FIG. 1), in order to visualize the speed of the distributor disk 2, which is the right-hand distributor disk in FIG. 1, as well as preferably also the speed of the distributor disk 1, which is the left-hand distributor disk in FIG. 1 and is preset by the power take-off shaft of the tractor, on a suitable display device, wherein the speed sensor(s) may be in functional connection especially with a control and/or regulating unit, by means of which the variable (output) speed of the distributor disk, which is the right-hand distributor disk in FIG. 1, can be controlled and/or regulated according to a desired set point by the control and/or regulating unit being also in functional connection with the actuator-type adjusting element 200 of the reducing gear 100 in order to control and/or regulate the speed reduction ratio thereof in a corresponding manner.

As it will appear, furthermore, especially from FIGS. 2 through 7, the reducing gear 100 configured as a mechanical coaxial transmission in the exemplary embodiment shown in the drawings is a friction clutch transmission, in which the section of the driven shaft 102 facing the input shaft 101 is configured as a hollow shaft and it circumferentially surrounds the circumference of the section of the input shaft 101, which section faces the driven shaft 102, at a radially spaced location therefrom. A plurality of approximately ring-shaped plates 103 of an inner plate pack, which extend radially outwardly from the input shaft 101, are arranged on the outer circumference of the section of the input shaft 101, which section faces the driven shaft 102. A plurality of likewise approximately ring-shaped plates 104 of an outer plate pack, which extend radially inwardly from the driven shaft 102, are arranged in a similar manner on the inner circumference of the—hollow—section of the driven shaft 102, which said section faces the input shaft 101, wherein the plates 103 of the input shaft 101 mesh between the plates 104 of the driven shaft 102 (and vice versa), so that the plates 103 of the input shaft 101 are arranged—when viewed in the axial direction—alternatingly with the plates 104 of the driven shaft 102. As will be explained in more detail below, the plates 103 of the input shaft 101 can be brought into contact in a non-positive manner with the plates 104 of the driven shaft 102 along their surfaces, which are arranged parallel and extend in the radial direction, in a non-positive or frictionally engaged manner, so that the plates 104 of the driven shaft 102 are either carried entirely by the plates 103 of the input shaft 101 (normal position of the reducing gear 100; the output speed corresponds to the input speed) or a variable slip develops depending on the axial pressure of the plates 103, 104 against one another (different speed reduction positions of the reducing gear 100; the output speed is lower than the input speed).

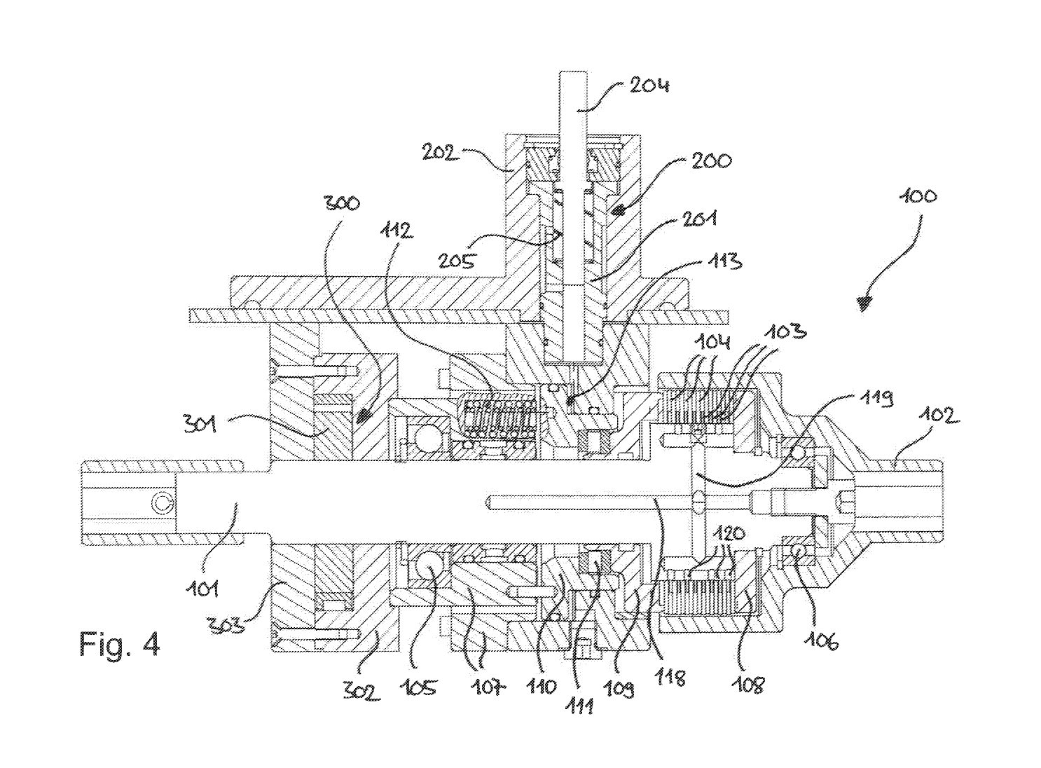

For the purpose of generating this variable axial pressure to stress the plates 103 of the input shaft 101 against the plates 104 of the driven shaft 102, the input shaft 101, which is otherwise mounted rotatably but in an axially fixed manner in this exemplary embodiment by means of suitable rolling bearings 105, 106, for example, ball bearings, in a stationary gearbox 107, on the one hand, and in the interior of the section of the driven shaft 102, which is configured as a hollow shaft and faces it, on the other hand, is provided in the area of its free end facing the driven shaft 102 with a pressure disk 108, which is seated in an axially fixed manner on the input shaft 101 and extends away from same to the outside in the radial direction (cf. especially FIGS. 3, 4 and 7). Further, a pressing ring 109, which is axially displaceable in relation to the input shaft 101 and which surrounds the outer circumference of the input shaft 101 and is arranged at a greater distance from the free end thereof facing the driven shaft 102 than the pressure disk 108, is provided at an axial distance from the pressure disk 108. The plates 103 of the input shaft and the plates 104 of the driven shaft 102, which can be brought into contact with it in a non-positive or frictionally engaged manner, are arranged here, likewise when viewed in the axial direction, between the (axially fixed) pressure disk 108 and the (axially displaceable) pressing ring 109. The pressing ring 109 is mechanically prestressed against the pressure disk 108 in the axial direction in this exemplary embodiment, for example, by means of a likewise approximately ring-shaped pressing element 110, which is in axial supporting contact with the pressing ring 109 by means of a thrust bearing 111, so that the plates 103, 104, located between the pressure disk 106 and the pressing ring 109 in the axial direction, are prestressed towards one another in order to prestress them towards one another in the direction of the normal position of the reducing gear, in which the input speed of the reducing gear corresponds to the output speed, in such a way that they are brought into contact with one another in a non-positive or frictionally engaged manner. The mechanical prestressing in the direction of the normal position is brought about in this case by means of spring force, and, for example, a plurality of, here, e.g., five coil springs 112 may be provided here, which are shown graphically exclusively in the longitudinal sections shown in FIGS. 3 and 4, and are supported in axial blind holes in the interior of the gearbox 107, on the one hand, and on the side of the pressing element 110, which side is the side opposite the pressing ring 109, on the other hand. The axial blind holes provided with the coil springs 112 are preferably arranged distributed equidistantly around the circumference of the input shaft 101 in order to ensure a uniform axial prestressing of the pressing element 110 and hence of the pressing ring 109 against the plates 103, 104, which are, in turn, pressed against the pressure disk 108 and are compressed between the pressing ring 109 and the pressure disk 108.

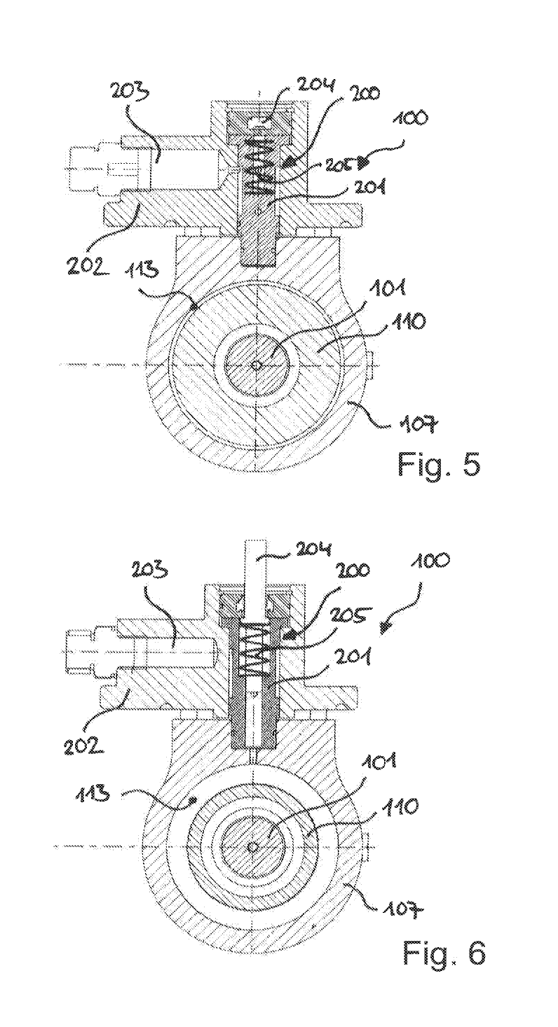

As is seen especially in FIGS. 3 through 6, the actuator-type adjusting element 200 of the mechanical coaxial transmission 100 configured as a friction clutch transmission has in this exemplary embodiment a piston-and-cylinder unit, whose cylinder 201 is mounted in an adjusting element housing 202 fixed on the gearbox 107 and can be filled by means of a closable inlet 203 (see FIGS. 5 and 6) with a suitable pressurized fluid, for example, hydraulic oil. The piston 204 guided axially displaceably in the cylinder 201 is prestressed in this case in its position according to FIG. 4, in which it is pulled out of the cylinder and in which consequently a minimum hydraulic pressure prevails in the interior of the cylinder 201, for example, by means of a coil spring 205 acting between a circumferential shoulder of the piston 204, which shoulder is arranged in the interior of the cylinder 201, and an inner circumferential projection of the cylinder 201. At its end face located opposite the coil spring 205, which end face is arranged outside the cylinder 201 and is the upper end face in FIGS. 3 through 6, the piston 204 of the piston-and-cylinder unit of the actuator-type adjusting element 200 is in connection with an, e.g., hydraulic, electrical or electromagnetic adjusting cylinder, not shown in the drawings, by means of which the piston 204 can be pushed into the cylinder 201 against the spring force in a controllable and/or regulatable manner (FIG. 3), in order to increase the hydraulic pressure in the interior of the cylinder 201 or to reduce it when the piston 204 is pushed out of the cylinder 201 by means of the adjusting cylinder (FIG. 4).

The cylinder 201 of the piston-and-cylinder unit of the actuator-type adjusting element 200 opens at its end, which faces away from the piston rod of the piston 204, on which piston rod the adjusting cylinder (not shown) acts, into an annular space 113 formed in the interior of the gearbox 107. Said annular space is located, when viewed in the axial direction, between the pressing element 110 of the pressing ring 109 and the gearbox 107 receiving same and is used to axially displace the pressing element 110 together with the pressing ring 109 as a function of the pressure prevailing in the annular space 113, which is sealed for this purpose in a compression-proof manner against both the pressing element 110 and the gearbox 107 by means of suitable axial face seals.

Consequently, if the hydraulic pressure is increased in the annular space 113 configured as a pressure chamber (the piston 204 of the piston-and-cylinder unit of the actuator-type adjusting element is transferred by means of the adjusting cylinder, not shown, from its extended position according to FIG. 4 into its position withdrawn into the cylinder 101 according to FIG. 3), the pressing element 110 and the pressing ring 109 are displaced against the mechanical prestress brought about by the coil springs 112 away from the plates 103, 104 of the input shaft 101 and of the driven shaft 102, i.e., to the left from the position shown in FIG. 4, which is the right-hand position, corresponding to FIG. 3, whereupon a slip develops between the plates 103, 104, which slip depends on the respective axial position of the pressing ring 109, and the output speed is reduced relative to the input speed. In the situation shown in FIG. 3, the pressing element strikes the inner wall of the gearbox 107, which inner wall is provided with the springs 112, which leads to a maximum pressure release on the plates 103, 104, and consequently to a maximum slip between same and hence to a maximum speed reduction of the gear 100.

If, by contrast, the hydraulic pressure is reduced in the annular space 113 configured as a pressure chamber (the piston 204 of the piston-and-cylinder unit of the actuator-type adjusting element is transferred by means of the adjusting cylinder, not shown, from its pushed-in position according to FIG. 3 into its position according to FIG. 4, in which it is extended from the cylinder, the pressing element 110 and the pressing ring 109 are displaced based on the mechanical prestress brought about by the coil springs 112 towards the plates 103, 104 of the input shaft 101 and of the driven shaft 102, i.e., to the right from the (stop) position, which is the left-hand position in FIG. 3, and into the normal position of the gear 100 shown in FIG. 4, whereupon the slip between the plates 103, 104, which depends on the particular axial position of the pressing ring 109, decreases and the output speed is increased. In the normal position of the reducing gear 100 shown in FIG. 4, the annular space 113 then has a minimum volume, which may otherwise also be practically equal to zero, so that the pressing element 110 strikes the adjusting element housing 202 (not shown) on the right. As a consequence of the axial prestress on the plates 103, 104 towards one another, no slip can consequently occur any longer, so that the output speed corresponds to the input speed. Consequently, if the pressure on the piston-and-cylinder unit 201, 204 of the actuator-type adjusting element 200 is released, the reducing gear 100 is in the normal position, without supply of energy being necessary. Any desired intermediate positions, which lead to different slips of the plates 103, 104 and consequently to different speed reduction ratios of the reducing gear 100, are, of course, possible between the end positions of the piston 204 of the piston-and-cylinder unit of the adjusting element 200, which are shown in FIGS. 3 and 4, on the one hand, and the unit formed from the pressing element 110 and the pressing ring 109, on the other hand.

It is also possible that the speed sensors interact with position transducers (not shown), which are arranged on a respective cross shaft 11, 11a or on a respective carrier shaft 4 carrying a respective distributor disk 1, 2, so that, for example, when the speed sensor(s) has/have detected an unfavorable relative position of one distributor disk relative to the other distributor disk 1, 2 (e.g., fertilizer collisions of the spreading fans thrown off by the distributor disks 1, 2 occur as a consequence of a certain relative arrangement of the throwing blades 3 of the distributor disks 1, 2), the hydraulic pressure is briefly changed, i.e., increased or decreased, in the annular space 113 configured as a pressure chamber, as a result of which the speed of one distributor disk 2 changes briefly and the relative position of the throwing blade 3 thereof will change relative to that of the other distributor disk 1.

To ensure a very low-friction and consequently wear-insensitive operation of the reducing gear 100 as well as satisfactory energy dissipation of the power loss usually generated as heat in case of the (random) speed reduction positions, in which a slip occurs between the plates 103, 104 of the input shaft 101 and of the driven shaft 102, the coaxial reducing gear 100 configured as a friction clutch transmission is further equipped with a pump 300, which may be configured in this case as a centrifugal pump or especially as a vane-type rotary pump and has a pump wheel 301 rotating coaxially with the input shaft 101 and with the driven shaft 102 (cf. FIG. 2 as well as especially FIGS. 3, 4 and 7). The pump wheel 301 is mounted rotatably in a pump housing 302, which is fixed on the input-side end face of the gearbox 107 and closes the latter on the input side. The pump housing 302 is, in turn closed on its side facing away from the gearbox 107 (left-hand side in FIGS. 3, 4 and 7) by means of a housing cover 303, which is screwed, e.g., to the pump housing 302. The pump wheel 301 has an unpowered configuration and is only carried by the input shaft 101, which has for this purpose, for example, an outer profile (not shown in the drawings), which meshes with an inner profile of the pump wheel 301 (likewise not shown in the drawings) non-rotatably but axial displaceably in order to make it possible to remove the pump 300 from the gearbox 107 in a simple manner. Any other non-rotatable connections are, of course, also possible, as an alternative, between the pump wheel 301 and the input shaft 101, such as the shaft-hub connections, feather key connections known from the state of the art, and the like.

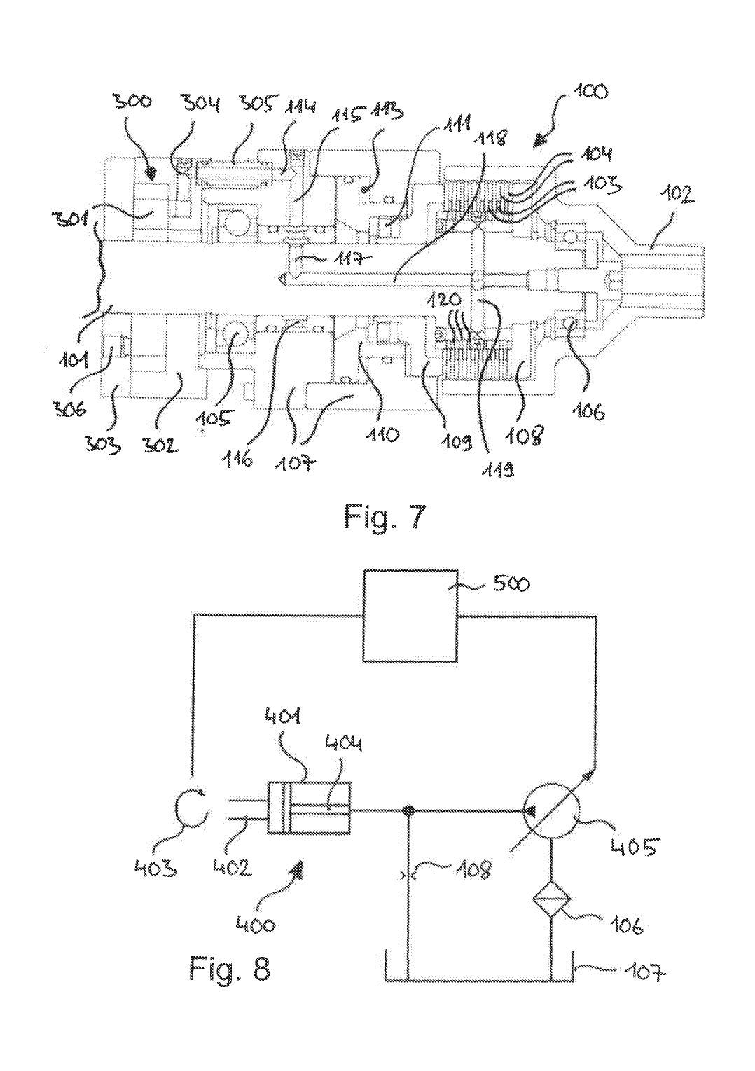

As is seen especially in FIG. 7, a delivery-side port 304 of the pump 300, arranged in the area of the outer circumference of the pump wheel 301 facing the gearbox 107, is in connection with a fluid duct, which opens at the plates 103, 104 of the input shaft 101 and of the driven shaft 102, which plates can be brought into contact in a non-positive manner. The fluid duct comprises in this exemplary embodiment a connection piece 305, which can be plugged in a pressure-sealed manner into the delivery-side port 304 of the pump, on the one hand, and into a fluid port 114 of the gearbox 107, on the other hand, and which extends in the axial direction of the input shaft 101, but eccentrically thereto, and can consequently be arranged in a simple manner between the ports 304, 114 when the pump housing 302 is placed on the gearbox 107. The fluid port 114 of the gearbox 107 opens into a connection duct 115, which passes radially through the gearbox 107 and which is in connection with a radial branch canal 117 of the input shaft 101. The radial branch canal 117 of the input shaft 101 opens, in turn, into an axial duct 118, which preferably extends coaxially to the axis of rotation of the input shaft 101 and which is in connection with one or preferably with a plurality of, e.g., four radial ducts 119 at its end facing the plates 103, 104. The radial ducts 119 open at their (outer) ends facing away from the axial duct 118 to the outer circumference of the input shaft 101, which outer circumference is provided with the plates 103, and they preferably branch into a plurality of outlets 120 arranged next to each other in the axial direction in order to distribute the fluid delivered by means of the pump 300, which fluid may be, for example, oil, directly into the intermediate spaces between respective adjacent plates 103 of the input shaft 101, with which the plates 104 of the driven shaft 102 mesh from the outside. The fluid pumped in this manner between the plates 103, 104 of the input shaft 101 and of the driven shaft 102 can leave the plate packs, for example, by means of an annular gap, which is formed between the gearbox 107 and the hollow end of the driven shaft 102, which end faces the input shaft 101, after which it can again be drawn in, e.g., via a suction-side port 306 of the pump 300 (cf. FIGS. 3, 4 and 7), which port passes axially through the cover 303 of the pump housing 302 in this exemplary embodiment and leads to the suction side of the pump wheel 301. As can be seen in FIG. 2, a pipe elbow, which leads radially downward and outward in order to draw in oil from the oil sludge at the bottom reliably and to feed it again to the plate packs via the fluid duct 305, 115, 116, 117, 118, 119, 120, may advantageously be connected to the suction-side port 306 of the pump 300. This reliably leads to continuous lubrication of the plate packs during the operation, and, in particular, heat generated in case of slip as a consequence of friction can also be reliably dissipated.

FIG. 8 shows an alternative embodiment of an adjusting element 400 in the form of a schematic diagram to the actuator-type adjusting element 200 of the friction clutch transmission 100 according to FIGS. 2 through 7. The adjusting element 400 has, in turn, a, e.g., hydraulic piston-and-cylinder unit, whose cylinder 401 receives a hydraulic fluid and is in fluidic connection with the annular space 113 (cf. FIGS. 3 through 7) of the friction clutch transmission 100 via a hydraulic line 402 in order to change the speed reduction ratio of said friction clutch transmission, indicated by the arrow 403, in a corresponding manner, as this happens in the embodiment according to FIGS. 2 through 7, which was explained above. Contrary to this, the piston 404 of the piston-and-cylinder unit cannot, however, be actuated by means of an (electrical) adjusting cylinder, but by means of a controllable and/or regulatable pump 405, which is in fluidic connection with the cylinder 401 of the piston-and-cylinder unit, specifically on the side of the piston 404 located opposite the pressure line 402, in order to displace the piston 404 relative to the cylinder 401 and to change in the process the pressure in the annular space 113 of friction clutch transmission 100 (cf. FIGS. 2 through 7) via the pressure line 402 (cf. FIGS. 2 through 7), so that the plates 103, 104 are compressed or decompressed as a consequence of the axial displacement of the pressing ring 109 and of the pressing element 110 and the speed reduction ratio is varied based on the different slip of the plates 103, 104. The pump 405 is supplied from a fluid reservoir 107, for example, via the intermediary of a filter 106. In addition, a pressure sensor is provided in this case, which is configured, for example, in the manner of a diaphragm valve or a measuring diaphragm 108, and which is in functional connection, just like the pump 405, with a control and/or regulating unit 500 in order to control and/or to regulate the speed reduction ratio of the gear 100 according to a desired set point. The control and/or regulating unit 500 may further be connected, as was mentioned above, to one or more speed sensor(s) (not shown) for detecting the output speed of the gear 100 and also be used to control and/or to regulate the other set parameters of the distributor, such as the feed point, the dose and the like.

Further, it is also possible, in principle, that the pump 405 communicates directly with the annular space 113 of the friction clutch transmission 100 (cf. FIGS. 2 through 7) via the pressure line 402, so that the piston-and-cylinder unit 401, 404 is unnecessary. Moreover, any other adjusting elements are conceivable for the friction clutch transmission 100.

While specific embodiments of the invention have been shown and described in detail to illustrate the application of the principles of the invention, it will be understood that the invention may be embodied otherwise without departing from such principles.

1. A distributor comprising:
a drive train;
at least two distributor disks rotatably driven by the drive train wherein the drive train is connectable to a power take-off shaft of a traction unit or of a tractor, and the drive train comprises:
a central input shaft
a central gear;
at least one cross shaft to drive a respective one of the distributor disks,
at least one reducing gear of variable output speed, arranged downstream of the central gear for rotation of one of the distributor disks at a speed different from that of another of the distributor disks, wherein the reducing gear comprises an adjusting element to change output speed and is configured as a mechanical coaxial transmission with an input shaft connected to the cross shaft and with a driven shaft is arranged coaxially to the cross shaft, wherein the coaxial transmission is configured as a friction clutch transmission that is adjustable by means of the adjusting element essentially continuously between a plurality of speed reduction positions, wherein a speed reduction ratio of the friction clutch transmission can be changed by means of the adjusting element between a normal position, in which the input speed of the input shaft corresponds essentially to the driven shaft, and reduction positions, in which the input speed of the input shaft is not equal to the output speed of the driven shaft.

2. A distributor in accordance with claim 1, wherein coaxial transmission is arranged in a housing accommodating the cross shaft or is integrated in such a housing, wherein the adjusting element passes through the housing.

3. A distributor in accordance with claim 2, wherein the adjusting element passes through the housing.

4. A distributor in accordance with claim 1, wherein the friction clutch transmission has a plurality of speed reduction positions with different output speeds.

5. (canceled)

6. A distributor in accordance with claim 4, wherein a speed sensor is arranged:
on an output side of the friction clutch transmission; or
on the an input side of the friction clutch transmission; or
on an input side of the friction clutch transmission and on the an output side of the friction clutch transmission; and further comprising
a control/regulating unit further connected to the speed sensors whereby an output speed can be controlled or regulated or controlled and regulated according to a set point.

7-8. (canceled)

9. A distributor in accordance with claim 1, wherein both the input shaft of the friction clutch transmission and the driven shaft thereof have each at least one plate, which can be brought into contact with one another in a non-positive connection.

10. A distributor in accordance with claim 9, wherein both the input shaft of the friction clutch transmission and the driven shaft thereof have each a plurality of plates.

11. A distributor in accordance with claim 9, wherein the plates of the input shaft and of the driven shaft can be pressed with variable pressure towards one another by means of a pressing ring displaceable in the axial direction in order to change the slip occurring during the operation between the at least one plate of the input shaft and the at least one plate of the driven shaft and consequently the output speed.

12. (canceled)

13. A distributor in accordance with claim 11, wherein the adjusting element of the friction clutch transmission comprises an actuator adjusting element wherein the actuator-type adjusting element of the friction clutch transmission has a hydraulic, pneumatic or hydropneumatic piston-and-cylinder unit.

14. (canceled)

15. A distributor in accordance with claim 13, wherein a cylinder of the piston-and-cylinder unit of the actuator adjusting element is in connection with an annular space arranged in a housing of the friction clutch transmission, which annular space adjoins the pressing ring in the axial direction and is used to displace same axially as a function of the pressure prevailing in the annular space.

16. A distributor in accordance with claim 9, wherein the plates of the input shaft and of the driven shaft are mechanically:
prestressed toward one another in order to bring them into contact with one another in a non-positive connection; or
prestressed away from one another in order to bring them out of contact from one another, wherein the plates of the input shaft and of the driven shaft are stressable away from one another by means of the adjusting element against the mechanical prestress to increase the slip, or are prestressable towards one another by means of the adjusting element against the mechanical prestress to reduce the slip.

17. A distributor in accordance with claim 16, wherein the plates of the input shaft and of the driven shaft are prestressed.

18. A distributor in accordance with claim 1, wherein a slip-free contact is formed between the input shaft of the friction clutch transmission and the driven shaft thereof during the normal operation, so that the input speed corresponds to the output speed.

19. A distributor in accordance with claim 14, wherein the actuator adjusting element further comprises:
a hydraulic, electrical or electromagnetic adjusting element or a piezo motor, which is in mechanical connection with a piston of the hydraulic, pneumatic or hydropneumatic piston-and-cylinder unit in order to actuate the piston thereof; or
a controllable and/or regulatable pump, which is in fluidic connection with a cylinder of the hydraulic, pneumatic or hydropneumatic piston-and-cylinder unit, in order to actuate the piston thereof.

20. A distributor in accordance with claim 1, wherein the friction clutch transmission further has a pump configured in the form of a vane-type rotary pump or centrifugal pump with a delivery-side port in operative connection with a fluid duct which opens at the plates of the input shaft and of the driven shaft which plates can be brought into contact with one another in a non-positive connection.

21. (canceled)

22. A distributor in accordance with claim 20, wherein the pump has an unpowered configuration wherein a pump wheel of the pump is connected non-rotatably to the input shaft.

23. (canceled)

24. A distributor in accordance with claim 20, wherein the pump can be attached to an end face of the friction clutch transmission.
